(19) United States
(12) Patent Application Publication
(10) Pub. No.: US 2020/0036255 A1
(43) Pub. Date: Jan. 30, 2020

(54) STATOR UNIT AND ELECTRIC ACTUATOR

(71) Applicant: NIDEC TOSOK CORPORATION, Kanagawa (JP)

(72) Inventors: Hiroshi SHIRAI, Kanagawa (JP); Shuichi KINJO, Kanagawa (JP); Kazuhiro SAITO, Kanagawa (JP)

(73) Assignee: NIDEC TOSOK CORPORATION, Kanagawa (JP)

(21) Appl. No.: 16/515,045

(22) Filed: Jul. 18, 2019

(30) Foreign Application Priority Data
Jul. 27, 2018 (JP) 2018-141257

(51) Int. Cl. H02K 3/52; H02K 1/14; H02K 3/38; H02K 7/116; H02K 11/33

(52) U.S. Cl. CPC H02K 3/522; H02K 1/146; H02K 3/38; H02K 2211/03; H02K 11/33; H02K 2203/06; H02K 2203/09; H02K 7/116

(57) ABSTRACT

The stator of the stator unit has a stator core in an annular shape along a circumferential direction, an insulator attached to the stator core, and coils attached to the stator core via the insulator. The bus bar unit of the stator unit has a bus bar holder for holding the bus bar on one side in an axial direction of the insulator. The bus bar has a terminal part extending closer to the one side in the axial direction than the bus bar holder and a coil connection part connected to a coil lead wire drawn from the coils to the one side in the axial direction. One of the bus bar holder and the insulator has claw parts protruding in the radial direction, and the other of them has a hooking part to which the claw parts are hooked and fixed in the axial direction.

### CROSS-REFERENCE TO RELATED APPLICATION

This application claims the priority of Japan patent application serial no. 2018-141257, filed on Jul. 27, 2018. The entirety of the above-mentioned patent application is hereby incorporated by reference herein and made a part of this specification.

### BACKGROUND

### Technical Field

The disclosure relates to a stator unit and an electric actuator.

### Description of Related Art

A motor is known in which a winding end drawn from a winding is connected to a bus bar. For example, Patent Document 1 discloses a configuration in which a winding end is passed through a through hole of an insulating plate for holding a bearing and is connected to a bus bar terminal.

### RELATED ART

### Patent Document

[Patent Document 1] International Publication No. WO 2008/146502

### Technical Problem

In the configuration as described above, the winding end drawn from the winding has relatively low rigidity and its position is easy to move. Therefore, it is difficult to align the position of the winding end, and it is difficult to pass the winding end through the through hole of the insulating plate. As a result, there has been a problem that the effort required for connection between the winding end and the bus bar terminal is increased.

### SUMMARY

An aspect of the stator unit of the disclosure is a stator unit of a motor which has a motor shaft rotating with a central axis as a center and a rotor body fixed to the motor shaft, and the stator unit includes a stator facing a rotor body in a radial direction with a gap therebetween and a bus bar unit having a bus bar electrically connected to the stator. The stator has a stator core in an annular shape along a circumferential direction, an insulator attached to the stator core, and a plurality of coils attached to the stator core via the insulator. The bus bar unit has a bus bar holder for holding the bus bar on one side in an axial direction of the insulator. The bus bar has a terminal part extending closer to the one side in the axial direction than the bus bar holder and a coil connection part connected to a coil lead wire drawn from the coils to the one side in the axial direction. One of the bus bar holder and the insulator has claw parts protruding in the radial direction. The other of the bus bar holder and the insulator has a hooking part to which the claw parts are hooked and fixed in the axial direction.

An aspect of the electric actuator of the disclosure includes a motor which has a motor shaft rotating with a central axis as a center, a rotor body fixed to the motor shaft, and the above-described stator unit; a deceleration mechanism connected to a part on the other side in the axial direction of the motor shaft; an output part to which rotation of the motor shaft is transmitted via the deceleration mechanism; a first case which accommodates the motor and has a first opening part that opens on the other side in the axial direction; a second case which is located on the other side in the axial direction of the first case and has a second opening part that opens on the one side in the axial direction; and a circuit board electrically connected to the bus bar. The first case has a case cylinder part in a cylindrical shape extending in the axial direction and a partition wall part expanding from an inner circumferential surface of the case cylinder part toward a radial-direction inner side. The stator is fixed to a part in the inner circumferential surface of the case cylinder part closer to the other side in the axial direction than the partition wall part. The circuit board is accommodated in a part in an inner part of the case cylinder part closer to the one side in the axial direction than the partition wall part. The partition wall part has a hole part passing through the partition wall part in the axial direction. The terminal part protrudes closer to the one side in the axial direction than the partition wall part through the hole part and is connected to the circuit board.

### Effects

### BRIEF DESCRIPTION OF THE DRAWINGS

FIG. 1 is a cross-sectional view showing an electric actuator of the embodiment.

FIG. 2 is a cross-sectional view showing a part of the electric actuator of the embodiment and is a cross-sectional view taken along II-II in FIG. 1.

FIG. 3 is a perspective view showing a stator unit of the embodiment.

FIG. 4 is a view of the stator unit of the embodiment as viewed from the upper side.

FIG. 5 is a cross-sectional view showing a part of the stator unit of the embodiment and is a cross-sectional view taken along V-V in FIG. 4.

FIG. 6 is a perspective view showing a bus bar unit of the embodiment.

### DESCRIPTION OF THE EMBODIMENTS

In view of the above-described circumstances, the disclosure has an object to provide a stator unit having a structure that can easily connect a coil lead wire and a bus bar, and an electric actuator including a motor having such a stator unit.

### Solution to the Problem

According to an aspect of the disclosure, in the stator unit, the coil lead wire and the bus bar can be easily connected.

The Z-axis direction in each drawing is a vertical direction in which the positive side is the upper side and the negative side is the lower side. The axial direction of a central axis J1 appropriately shown in each drawing is parallel to the Z-axis direction, that is, the vertical direction. In the following description, a direction parallel to the axial direction of the central axis J1 is simply referred to as the “axial direction Z.” Further, the X-axis direction and the Y-axis direction appropriately shown in each drawing are horizontal directions orthogonal to the axial direction Z and are directions orthogonal to each other. In the following description, a direction parallel to the X-axis direction is referred to as the “first direction X,” and a direction parallel to the Y-axis direction is referred to as the “second direction Y.”

Further, a radial direction with the central axis J1 as the center is simply referred to as the “radial direction,” and a circumferential direction with the central axis J1 as the center is simply referred to as the “circumferential direction.” In the embodiment, the upper side corresponds to one side in the axial direction, and the lower side corresponds to the other side in the axial direction. Further, the vertical direction, the horizontal direction, the upper side and the lower side are simply names for explaining the relative positional relationship of each part, and the actual dispositional relationship and the like may be a dispositional relationship and the like other than the dispositional relationship and the like indicated by these names.

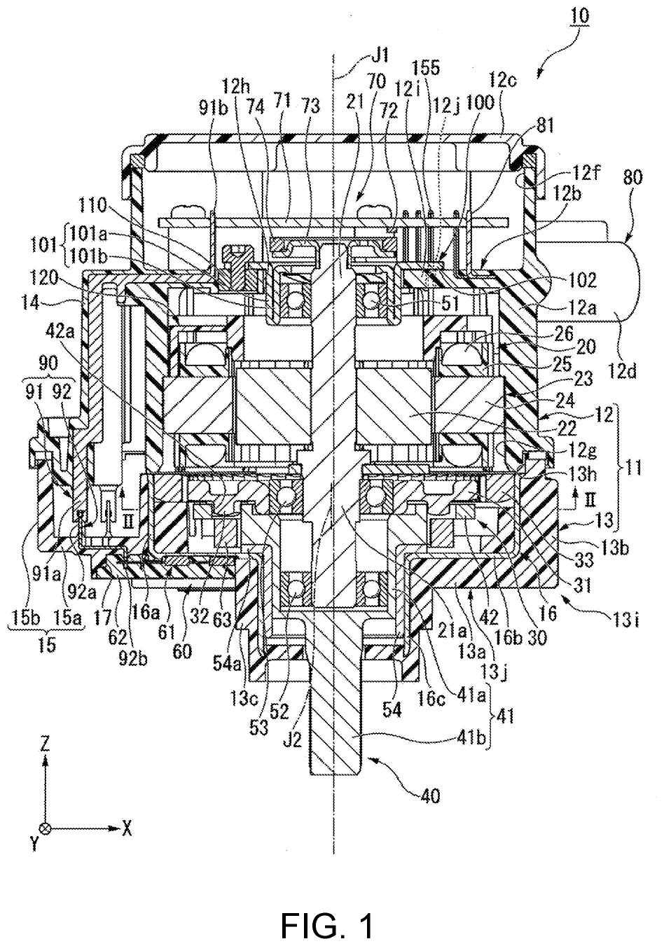

As shown in FIG. 1, an electric actuator 10 of the embodiment includes a case 11, a bearing holder 100, a motor 20 having a motor shaft 21 extending in the axial direction Z of the central axis J1, a control part 70, a connector part 80, a deceleration mechanism 30, an output part 40, a rotation detection device 60, a wiring member 90, a first bearing 51, a second bearing 52, a third bearing 53, and a bush 54. The first bearing 51, the second bearing 52, and the third bearing 53 are, for example, ball bearings.

The case 11 accommodates the motor 20 and the deceleration mechanism 30. The case 11 has a motor case 12 for accommodating the motor 20 and a deceleration mechanism case 13 for accommodating the deceleration mechanism 30. The motor case 12 corresponds to a first case. The deceleration mechanism case 13 corresponds to a second case. That is, the electric actuator 10 includes the motor case 12 as the first case and the deceleration mechanism case 13 as the second case. The motor case 12 has a case cylinder part 12a, a partition wall part 12b, a control board accommodating part 12f, an upper lid part 12c, a terminal holding part 12d, and a first wiring holding part 14. Each part of the motor case 12 is made of resin except for a metal member 110 to be described later.

The case cylinder part 12a is in a cylindrical shape that extends in the axial direction Z with the central axis J1 as the center. The case cylinder part 12a opens on both sides in the axial direction Z. The case cylinder part 12a has a first opening part 12g that opens on the lower side. That is, the motor case 12 has the first opening part 12g. The case cylinder part 12a surrounds the radial-direction outer side of the motor 20.

The partition wall part 12b is in an annular shape that expands from the inner circumferential surface of the case cylinder part 12a toward the radial-direction inner side. The partition wall part 12b covers the upper side of a stator 23 (to be described later) of the motor 20. The partition wall part 12b has a through hole 12h passing through the partition wall part 12b in the axial direction Z. In the embodiment, the through hole 12h is in a circular shape with the central axis J1 as the center. The inner diameter of the through hole 12h is greater than the outer diameter of a holder cylinder part 101 to be described later. The partition wall part 12b has a wall part body 12i made of resin and the metal member 110 made of metal. The wall part body 12i is part of the annular shape that expands from the inner circumferential surface of the case cylinder part 12a toward the radial-direction inner side. The partition wall part 12b has a hole part 12j passing through the partition wall part 12b in the axial direction Z. In the embodiment, the hole part 12j is provided in the wall part body 12i.

The metal member 110 is in an annular shape and has an internal thread part on its inner circumferential surface. The metal member 110 is, for example, a nut. The metal member 110 is embedded in the wall part body 12i. More specifically, the metal member 110 is embedded in the radial-direction inner edge part in the wall part body 12i. The metal member 110 is located at a position closer to the radial-direction outer side than the radial-direction inner-side surface of the through hole 12h. The upper-side surface of the metal member 110 is located above the upper-side surface of the wall part body 12i. The upper-side surface of the metal member 110 is a flat surface orthogonal to the axial direction Z. Though omitted in the drawings, a plurality of metal members 110 are provided in the embodiment. The plurality of metal members 110 are disposed at equal intervals all around along the circumferential direction. For example, three metal members 110 are provided.

The control board accommodating part 12f is a part for accommodating a circuit board 71 to be described later. The control board accommodating part 12f is configured on the radial-direction inner side of the upper-side part of the case cylinder part 12a. The bottom surface of the control board accommodating part 12f is the top surface of the partition wall part 12b. The control board accommodating part 12f opens on the upper side. The upper lid part 12c is a lid in a plate shape that closes the upper-end opening of the control board accommodating part 12f. The terminal holding part 12d protrudes from the case cylinder part 12a toward the radial-direction outer side. The terminal holding part 12d is in a cylindrical shape that opens on the radial-direction outer side. The terminal holding part 12d holds a terminal 81 to be described later.

The first wiring holding part 14 protrudes from the case cylinder part 12a toward the radial-direction outer side. In FIG. 1, the first wiring holding part 14 protrudes from the case cylinder part 12a toward the negative side of the first direction X. The first wiring holding part 14 extends in the axial direction Z. The axial-direction position of the upper end part of the first wiring holding part 14 is substantially the same as the axial-direction position of the partition wall part 12b. The circumferential-direction position of the first wiring holding part 14 is, for example, different from the circumferential-direction position of the connector part 80.

The deceleration mechanism case 13 is located at the lower side of the motor case 12. The deceleration mechanism case 13 has a deceleration mechanism case body 13i and a cylinder member 16. In the embodiment, the deceleration mechanism case body 13i corresponds to a second case body. The deceleration mechanism case body 13i is made of resin. The deceleration mechanism case body 13i has a bottom wall part 13a, a cylinder part 13b, a protruding cylinder part 13c, and a second wiring holding part 15. The bottom wall part 13a is in an annular shape with the central axis J1 as the center. The bottom wall part 13a covers the lower side of the deceleration mechanism 30.

The cylinder part 13b is in a cylindrical shape that protrudes from the radial-direction outer edge part of the bottom wall part 13a toward the upper side. The cylinder part 13b opens on the upper side. The upper end part of the cylinder part 13b is in contact with and fixed to the lower end part of the case cylinder part 12a. The protruding cylinder part 13c is in a cylindrical shape that protrudes from the radial-direction inner edge part of the bottom wall part 13a toward the lower side. The protruding cylinder part 13c opens on both sides in the axial direction.

The second wiring holding part 15 protrudes from the cylinder part 13b toward the radial-direction outer side. In FIG. 1, the second wiring holding part 15 protrudes from the cylinder part 13b toward the negative side of the first direction X, that is, the same side as the side toward which the first wiring holding part 14 protrudes. The second wiring holding part 15 is disposed at the lower side of the first wiring holding part 14. The second wiring holding part 15 is, for example, in a box shape that is hollow and opens on the upper side. The inner part of the second wiring holding part 15 is connected to the inner part of the cylinder part 13b. The second wiring holding part 15 has a bottom wall part 15a and a side wall part 15b. The bottom wall part 15a extends from the bottom wall part 13a toward the radial-direction outer side. In FIG. 1, the bottom wall part 15a extends from the bottom wall part 13a toward the negative side of the first direction X. The side wall part 15b extends from the outer edge part of the bottom wall part 15a toward the upper side.

In the embodiment, a bottom part 13j of the deceleration mechanism case body 13i is formed by the bottom wall part 13a and the bottom wall part 15a. The bottom part 13j has an accommodating recess part 17 which is recessed from the lower-side surface of the bottom part 13j toward the upper side. In the embodiment, the accommodating recess part 17 is provided across the bottom wall part 13a and the bottom wall part 15a.

The cylinder member 16 is in a cylindrical shape that extends in the axial direction Z. More specifically, the cylinder member 16 is in a multistage cylindrical shape that opens on both sides in the axial direction with the central axis J1 as the center. The cylinder member 16 is made of metal. In the embodiment, the cylinder member 16 is made of sheet metal. Therefore, the cylinder member 16 can be manufactured by press-processing a metal plate, and the manufacturing cost of the cylinder member 16 can be reduced. In the embodiment, the cylinder member 16 is made of a nonmagnetic material.

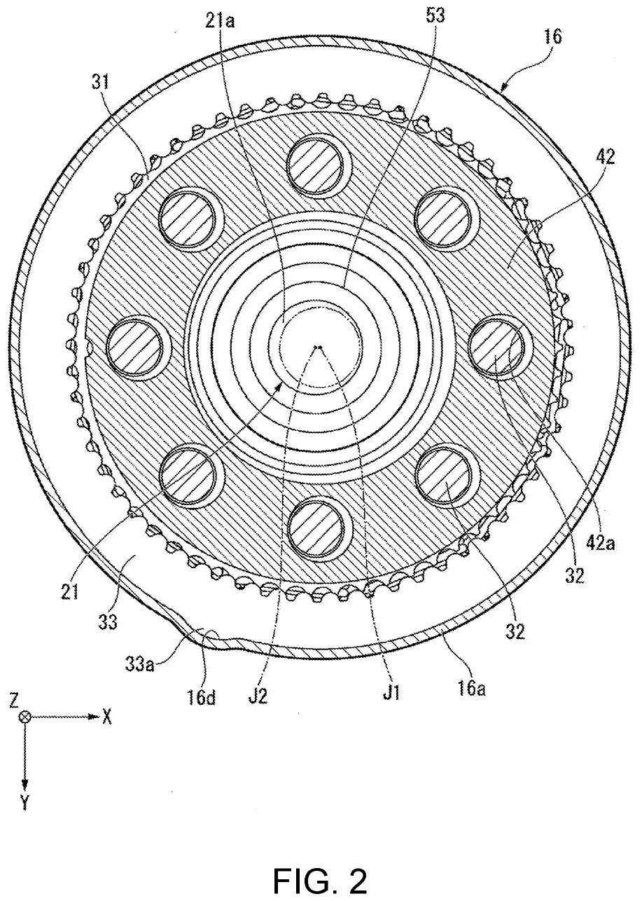

The cylinder member 16 is embedded in the deceleration mechanism case body 13i. The cylinder member 16 has a large diameter part 16a, an annular part 16b, and a small diameter part 16c. The large diameter part 16a is an upper-side part of the cylinder member 16. The large diameter part 16a is embedded in the cylinder part 13b. The upper-side end part in the inner circumferential surface of the large diameter part 16a is exposed to the inner part of the deceleration mechanism case 13. As shown in FIG. 2, the large diameter part 16a has a positioning recess part 16d that is recessed toward the radial-direction outer side in the inner circumferential surface. Further, in FIG. 2, illustration of the deceleration mechanism case body 13i is omitted.

As shown in FIG. 1, the annular part 16b is a part of the annular shape that extends from the lower-side end part of the large diameter part 16a toward the radial-direction inner side. In the embodiment, the annular part 16b is in an annular plate shape with the central axis J1 as the center. The annular part 16b is disposed on the bottom wall part 13a. In the embodiment, the annular part 16b is located on the upper-side surface of the bottom wall part 13a. The radial-direction outer edge part of the annular part 16b is embedded in the cylinder part 13b. A part closer to the radial-direction inner side in the upper surface of the annular part 16b is exposed to the inner part of the deceleration mechanism case 13. The annular part 16b covers the lower side of a first magnet 63 to be described later. The upper surface of the annular part 16b is a flat surface orthogonal to the axial direction Z.

The small diameter part 16c is a lower-side part of the cylinder member 16. The small diameter part 16c extends from the radial-direction inner edge part of the annular part 16b toward the lower side. The outer diameter and the inner diameter of the small diameter part 16c are smaller than the outer diameter and the inner diameter of the large diameter part 16a. The small diameter part 16c is fitted to the radial-direction inner side of the protruding cylinder part 13c. The bush 54 in a cylindrical shape that extends in the axial direction Z is disposed in the inner part of the small diameter part 16c. The bush 54 is fitted to the small diameter part 16c and is fixed inside the protruding cylinder part 13c. The bush 54 has a bush flange part 54a that protrudes to the radial-direction outer side at the upper end part. The bush flange part 54a contacts the upper surface of the annular part 16b. In this way, the bush can be suppressed from detaching from the inner part of the small diameter part 16c toward the lower side.

The deceleration mechanism case 13 has a second opening part 13h that opens on the upper side. In the embodiment, the second opening part 13h is formed by the opening on the upper side of the cylinder part 13b and the opening on the upper side of the second wiring holding part 15. The motor case 12 and the deceleration mechanism case 13 are fixed to each other in a state in which the first opening part 12g and the second opening part 13h face in the axial direction Z. In the state in which the motor case 12 and the deceleration mechanism case 13 are fixed to each other, the inner part of the first opening part 12g and the inner part of the second opening part 13h are connected to each other.

In the embodiment, the motor case 12 and the deceleration mechanism case 13 are each manufactured by, for example, insert molding. The motor case 12 is manufactured by insert molding using the metal member 110 and a first wiring member 91 (to be described later) in the wiring member 90 as an insert member. The deceleration mechanism case 13 is manufactured by insert molding using the cylinder member 16 and a second wiring member 92 (to be described later) in the wiring member 90 as an insert member.

The bearing holder 100 is fixed to the motor case 12. The bearing holder 100 is made of metal. In the embodiment, the bearing holder 100 is made of sheet metal. Therefore, the bearing holder 100 can be manufactured by press-processing a metal plate, and the manufacturing cost of the bearing holder 100 can be reduced. The bearing holder 100 has a holder cylinder part 101 in a cylindrical shape and a holder flange part 102. In the embodiment, the holder cylinder part 101 is in a cylindrical shape with the central axis J1 as the center. The holder cylinder part 101 holds the first bearing 51 on the radial-direction inner side. The holder cylinder part 101 is inserted into the through hole 12h. The holder cylinder part 101 protrudes from the inner part of the control board accommodating part 12f to the lower side lower than the partition wall part 12b via the through hole 12h.

The outer diameter of the holder cylinder part 101 is smaller than the inner diameter of the through hole 12h. Therefore, at least a part of the radial-direction outer-side surface of the holder cylinder part 101 in the circumferential direction is located at a position closer to the radial-direction inner side than the radial-direction inner-side surface of the through hole 12h. In the example shown in FIG. 1, the radial-direction outer-side surface of the holder cylinder part 101 is located at a position closer to the radial-direction inner side than the radial-direction inner-side surface of the through hole 12h along the entire circumference.

In the embodiment, the holder cylinder part 101 has an outer cylinder part 101a and an inner cylinder part 101b. The outer cylinder part 101a is in a cylindrical shape that extends from the radial-direction inner edge part of the holder flange part 102 toward the lower side. The radial-direction outer-side surface of the outer cylinder part 101a is the radial-direction outer-surface of the holder cylinder part 101. The inner cylinder part 101b is in a cylindrical shape that extends from the lower-side end part of the outer cylinder part 101a toward the upper side on the radial-direction inner side of the outer cylinder part 101a. The radial-direction outer-side surface of the inner cylinder part 101b contacts the radial-direction inner-side surface of the outer cylinder part 101a. In this way, the holder cylinder part 101 is formed by stacking the two cylinder parts in the radial direction, whereby the strength of the holder cylinder part 101 can be improved. The first bearing 51 is held on the radial-direction inner side of the inner cylinder part 101b. The upper-side end part of the inner cylinder part 101b is located above the first bearing 51. The upper-side end part of the inner cylinder part 101b is located slightly lower than the upper-side end part of the outer cylinder part 101a.

The holder flange part 102 extends from the holder cylinder part 101 toward the radial-direction outer side. In the embodiment, the holder flange part 102 extends from the upper-side end part of the holder cylinder part 101 toward the radial-direction outer side. The holder flange part 102 is in an annular plate shape with the central axis J1 as the center. The holder flange part 102 is located on the upper side of the partition wall part 12b. The holder flange part 102 is fixed to the partition wall part 12b. In this way, the bearing holder 100 is fixed to the motor case 12.

In the embodiment, the holder flange part 102 is fixed to the partition wall part 12b by a plurality of screw members that are tightened to the partition wall part 12b in the axial direction Z. In the embodiment, the screw members for fixing the holder flange part 102 are tightened to the internal thread parts of the metal members 110 in the partition wall part 12b. Though omitted in the drawings, for example, three screw members for fixing the holder flange part 102 are provided.

The holder flange part 102 fixed by the screw members contacts the upper-side surfaces the metal members 110. More specifically, in the lower-side surface of the holder flange part 102, the peripheral part of the through part through which the screw members pass contacts the upper-side surfaces of the metal members 110. The holder flange part 102 is located at a position closer to the upper side than the wall part body 12i. Therefore, the holder flange part 102 can be positioned with good accuracy in the axial direction Z by the metal members 110. In addition, the holder flange part 102 can be suppressed from inclining with respect to the axial direction Z. Further, the holder flange part 102 does not directly contact the wall part body 12i. Therefore, even when a difference in the amount of thermal deformation occurs between the wall part body 12i made of resin and the metal members 110 made of metal due to the difference in linear expansion coefficient, stress can be suppressed from applying to the wall part body 12i. As a result, breakage of the wall part body 12i, detachment of the metal members 110 from the wall part body 12i and the like can be suppressed.

The motor 20 has the motor shaft 21, a rotor body 22, and a stator unit 120. The motor shaft 21 rotates with the central axis J1 as the center. The motor shaft 21 is supported by the first bearing 51 and the second bearing 52 to be rotatable around the central axis J1. The first bearing 51 is held by the bearing holder 100 and supports a part of the motor shaft 21 above the rotor body 22 to be rotatable. The second bearing 52 supports a part of the motor shaft 21 below the rotor body 22 to be rotatable with respect to the deceleration mechanism case 13.

The upper end part of the motor shaft 21 protrudes closer to the upper side than the partition wall part 12b through the through hole 12h. The motor shaft 21 has an eccentric axis part 21a with an eccentric axis J2, which is eccentric with respect to the central axis J1, as the center. The eccentric axis part 21a is located below the rotor body 22. The inner ring of the third bearing 53 is fitted and fixed to the eccentric axis part 21a. The rotor body 22 is fixed to the motor shaft 21. Though omitted in the drawings, the rotor body 22 has a rotor core in a cylindrical shape fixed to the outer circumferential surface of the motor shaft 21 and has a magnet fixed to the rotor core.

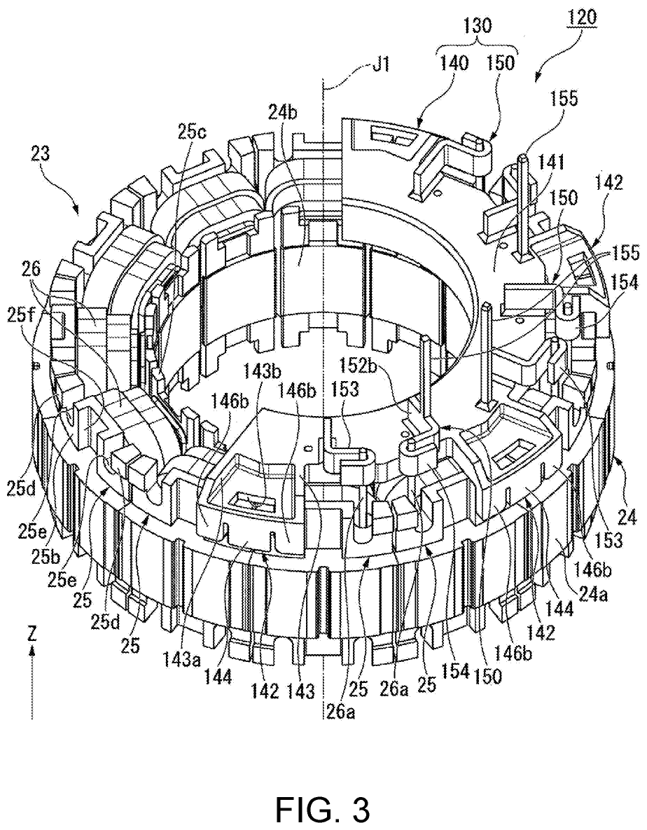

As shown in FIG. 3, the stator unit 120 includes the stator 23 and a bus bar unit 130. As shown in FIG. 1, the stator 23 faces the rotor body 22 in the radial direction with a gap therebetween. The stator 23 surrounds the rotor body 22 on the radial-direction outer side of the rotor body 22. The stator 23 has a stator core 24, an insulator 25, and a plurality of coils 26.

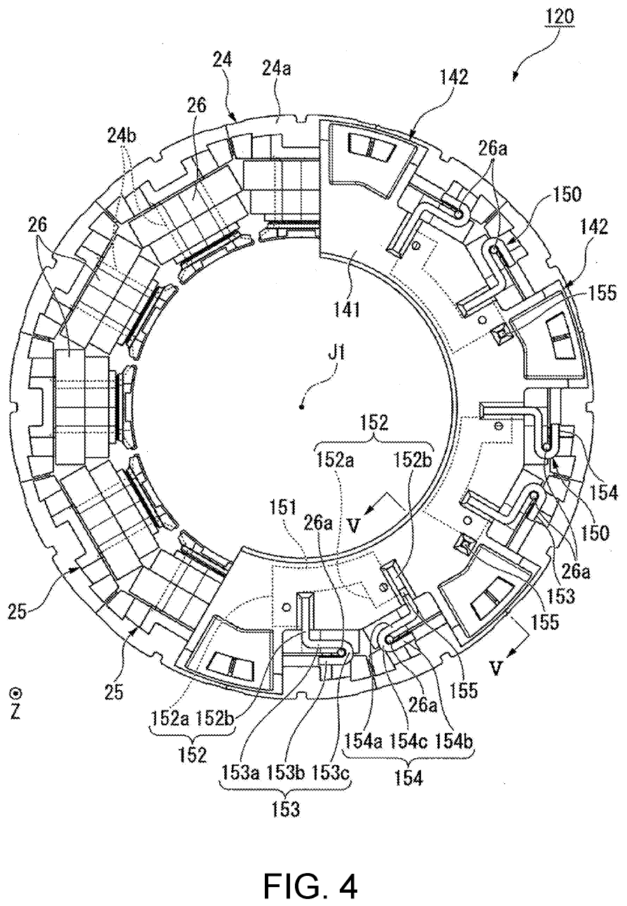

The stator core 24 is fixed to the inner circumferential surface of the case cylinder part 12a. More specifically, the stator core 24 is fixed to a part of the inner circumferential surface of the case cylinder part 12a below the partition wall part 12b. That is, the stator 23 is fixed to a part of the inner circumferential surface of the case cylinder part 12a below the partition wall part 12b. In this way, the motor 20 is held by the motor case 12. As shown in FIGS. 3 and 4, the stator core 24 is in an annular shape along the circumferential direction. In the embodiment, the stator core 24 is in an annular shape with the central axis J1 as the center. The stator core 24 has a core back part 24a and a plurality of teeth parts 24b. The core back part 24a is in an annular shape along the circumferential direction. In the embodiment, the core back part 24a is in an annular shape with the central axis J1 as the center. The plurality of teeth parts 24b extend from the core back part 24a in the radial direction. In the embodiment, the plurality of teeth parts 24b extend from the core back part 24a toward the radial-direction inner side. The plurality of teeth parts 24b are disposed at equal intervals all around along the circumferential direction. In the embodiment, twelve teeth parts 24b are provided, for example.

In the embodiment, the stator core 24 is formed by connecting a plurality of stator core pieces in the circumferential direction. Each of the plurality of stator core pieces has one core back piece that forms a part of the core back part 24a in the circumferential direction and one teeth part 24b that extends from the core back piece toward the radial-direction inner side. Both circumferential-direction end parts of the core back piece are in contact with and connected to circumferential-direction end parts of the core back piece adjacent in the circumferential direction.

The insulator 25 is attached to the stator core 24. More specifically, the insulator 25 is attached to the teeth parts 24b. In the embodiment, the insulator 25 is provided for each teeth part 24b. Therefore, in the embodiment, a plurality of insulators 25 are disposed at equal intervals all around along the circumferential direction. For example, twelve insulators 25 are provided. The insulator 25 is made of, for example, resin.

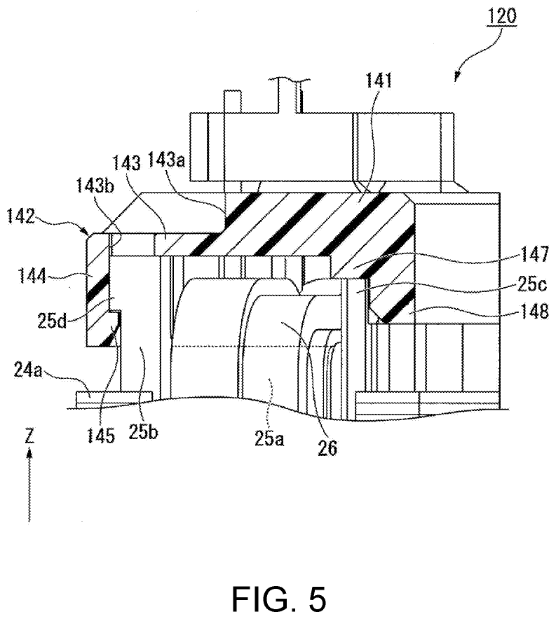

As shown in FIG. 5, the insulator 25 has a cylinder part 25a, an outer protrusion part 25b, an inner protrusion part 25c, and a hooking part 25d. The cylinder part 25a is in a cylindrical shape that extends in the radial direction. Each teeth part 24b is passed through the cylinder part 25a of each insulator 25. The coil 26 is wound and attached to each cylinder part 25a. In this way, the coil 26 is attached to the stator core 24 via the insulator 25.

The outer protrusion part 25b protrudes from the cylinder part 25a toward the upper side closer to the radial-direction outer side than the coil 26. The inner protrusion part 25c protrudes from the cylinder part 25a toward the upper side closer to the radial-direction inner side than the coil 26. The outer protrusion part 25b protrudes closer to the radial-direction outer side than the cylinder part 25a and contacts the upper-side surface of the core back part 24a. As shown in FIG. 3, the outer protrusion part 25b has a central recess part 25f and a fitting recess part 25e. That is, the insulator 25 has the central recess part 25f and the fitting recess part 25e. The central recess part 25f is recessed from the radial-direction outer-side surface of the outer protrusion part 25b toward the radial-direction inner side. The central recess part 25f is located at the circumferential-direction center of the outer protrusion part 25b. The central recess part 25f opens on both sides in the axial direction.

The fitting recess part 25e is recessed from the upper-side end part of the outer protrusion part 25b toward the lower side. The fitting recess part 25e passes through the outer protrusion part 25b in the radial direction. The lower-side surface of the inner-side surface of the fitting recess part 25e is in an arc shape recessed toward the lower side as viewed along the radial direction. In the embodiment, the fitting recess part 25e is provided in a pair with the central recess part 25f interposed in the circumferential direction.

In the embodiment, the hooking part 25d protrudes from the outer protrusion part 25b toward the radial-direction outer side. More specifically, the hooking part 25d protrudes from respective end parts of both sides in the circumferential direction at the upper-side end part of the outer protrusion part 25b toward the radial-direction outer side. A pair of hooking parts 25d protrude from the respective parts adjacent, in the circumferential direction, to the parts provided with the pair of fitting recess parts 25e in the outer protrusion part 25b toward the radial-direction outer side. In the embodiment, the pair of fitting recess parts 25e are located between the parts provided with the pair of hook parts 25d in the outer protrusion part 25b in the circumferential direction. The radial-direction outer-side end part of the hooking part 25d is located closer to the radial-direction inner side than the radial-direction outer-side surface of the core back part 24a. In the embodiment, the hooking part 25d is, for example, in a rectangular parallelepiped shape.

The coil 26 is formed by winding a conductive wire around the cylinder part 25a. In the embodiment, twelve coils 26 are provided, for example. A coil lead wire 26a is drawn toward the upper side from a part of the coils 26 in the plurality of coils 26. The coil lead wire 26a is an end part of the conductive wire forming the coil 26. In the embodiment, one coil lead wire 26a is drawn from each of six coils 26. Further, in each of the drawings, the illustration of the coils 26 is simplified.

The bus bar unit 130 has a bus bar holder 140 and a bus bar 150. The bus bar holder 140 holds the bus bar 150 on the upper side of the insulator 25. The bus bar holder 140 is made of, for example, resin. In the embodiment, the bus bar holder 140 is manufactured by insert molding using the bus bar 150 as an insert member.

The bus bar holder 140 has a bus bar holder body part 141 and a plurality of fixing parts 142. The bus bar holder body part 141 extends in the circumferential direction on the upper side of the insulator 25. As shown in FIG. 4, the schematic shape of the bus bar holder body part 141 is an arc shape with the central axis J1 as the center. The central angle of the bus bar holder body part 141 is 180° or more. In the embodiment, the central angle of the bus bar holder body part 141 is, for example, about 190°. The radial-direction inner edge of the bus bar holder body part 141 is in an arc shape with the central axis J1 as the center as viewed along the axial direction Z. The radial-direction outer edge of the bus bar holder body part 141 is in a broken-line shape with the central axis J1 as the center as viewed along the axial direction Z.

As shown in FIG. 5, the bus bar holder body part 141 is located above the coil 26. The radial-direction inner edge part of the bus bar holder body part 141 is located closer to the radial-direction inner side than the insulator 25 and the teeth part 24b. The radial-direction outer edge part of the bus bar holder body part 141 is located closer to the radial-direction inner side than the core back part 24a.

As shown in FIG. 4, the plurality of fixing parts 142 are connected to the radial-direction outer edge part of the bus bar holder body part 141. The plurality of fixing parts 142 are disposed along the circumferential direction. In the embodiment, the plurality of fixing parts 142 are disposed at equal intervals along the circumferential direction. For example, four fixing parts 142 are provided. Of the four fixing parts 142, two fixing parts 142 are respectively connected to end parts on both sides in the circumferential direction in the radial-direction outer edge part of the bus bar holder body part 141.

As shown in FIG. 5, the fixing part 142 has an arm part 143, an extending part 144, and a claw part 145. That is, the bus bar holder 140 has the arm parts 143, the extending parts 144, and the claw parts 145. The arm part 143 extends from the bus bar holder body part 141 toward the radial-direction outer side. The radial-direction outer-side end part of the arm part 143 is located closer to the radial-direction outer side than the outer protrusion part 25b. The radial-direction outer-side end part of the arm part 143 is located closer to the radial-direction inner side than the radial-direction outer-side surface of the core back part 24a. The radial-direction outer-side end part on the lower-side surface of the arm part 143 contacts the upper-side end part of the outer protrusion part 25b. In this way, the bus bar holder 140 is supported from the lower side by the outer protrusion part 25b. As shown in FIG. 3, the circumferential-direction dimension of the arm part 143 increases toward the radial-direction outer side. The arm part 143 is in a substantially trapezoidal shape as viewed along the axial direction Z.

The arm part 143 has a holder recess part 143a that is recessed toward the lower side. The holder recess part 143a is provided substantially in the entire arm part 143 except for both edge parts in the circumferential direction. The holder recess part 143 opens on the radial-direction outer side. The arm part 143 has a through part 143b passing through the arm part 143 in the axial direction Z. In the embodiment, the through part 143b is provided in the radial-direction outer-side end part on the bottom surface of the holder recess part 143a. The bottom surface of the holder recess part 143a is a surface facing the upper side and is a lower-side surface in the inner-side surface of the holder recess part 143a. The through part 143b is in a substantially rectangular shape that is long in the circumferential direction.

As shown in FIG. 5, the extending part 144 extends in the axial direction Z on the radial-direction outer side of the outer protrusion part 25b. In the embodiment, the extending part 144 extends from the radial-direction outer-side end part of the arm part 143 toward the lower side. The lower-side end part of the extending part 144 is located on the upper side away from the core back part 24a. As shown in FIG. 3, the circumferential-direction dimension of the extending part 144 is smaller than the circumferential-direction dimension of the arm part 143. The extending part 144 is connected to the circumferential-direction central part of the arm part 143.

As shown in FIG. 5, the claw part 145 protrudes in the radial direction. In the embodiment, the claw part 145 protrudes from the lower-side end part of the extending part 144 toward the radial-direction inner side. The claw part 145 is located at a position overlapping with the through part 143b as viewed along the axial direction Z. Therefore, when resin is poured into the mold for molding the bus bar holder 140, the part in the mold for manufacturing the claw part 145 can be easily removed from the through part 143b. In this way, the claw part 145 can be manufactured easily.

The claw part 145 is hooked from the lower side by the hooking part 25d on the radial-direction outer side of the outer protrusion part 25b. In this way, the claw part 145 is hooked and fixed to the hooking part 25d in the axial direction Z, and the bus bar holder 140 is fixed to the insulator 25. In the embodiment, the bus bar holder 140 is fixed to the insulator 25 by a snap fit. Specifically, when the bus bar holder 140 is brought close to the insulator 25 from the upper side, the claw part 145 contacts the hooking part 25d from the radial-direction outer side and is pushed toward the radial-direction outer side by the hooking part 25d. In this way, the extending part 144 elastically deforms on the radial-direction outer side. Then, when the bus bar holder 140 is further brought close to the insulator 25 and the claw part 145 is located lower than the hooking part 25d, the extending part 144 restoratively deforms on the radial-direction inner side and the claw part 145 enters the lower side of the hooking part 25d. In this way, the claw part 145 is hooked by the hooking part 25d, and the bus bar holder 140 is fixed to the insulator 25. As described above, according to the embodiment, by disposing the bus bar holder 140 on the insulator 25, the bus bar holder 140 can be easily fixed to the insulator 25 without using other members, adhesives, etc.

In the embodiment, the claw part 145 is collectively hooked by two hooking parts 25d. The two hooking parts 25d by which the claw part 145 is hooked are hooking parts 25d respectively provided on a pair of insulators 25 adjacent in the circumferential direction and are disposed adjacent to each other. That is, in the embodiment, the claw part 145 is hooked and fixed across two insulators 25.

In the embodiment, since one claw part 145 is provided in each fixing part 142, a total of four claw parts 145 are provided. The four claw parts 145 are disposed at equal intervals along the circumferential direction. Here, according to the embodiment, the claw part 145 protrudes toward the radial-direction inner side from the extending part 144 that extends in the axial direction Z on the radial-direction outer side of the outer protrusion part 25b. Therefore, it is easy to make the radial-direction position of the claw part 145 closer to the outer side. Thus, the plurality of claw parts 145 can be easily disposed to be further away in the circumferential direction. Therefore, the bus bar holder 140 can be more stably fixed to the insulator 25 by the plurality of claw parts 145.

In the embodiment, the claw parts 145 include at least two claw parts 145 which are spaced apart from each other by 180° or more in the circumferential direction along the bus bar holder body part 141. Therefore, even if a force is applied to the bus bar holder 140 in the detaching direction of one of the claw parts 145 in the radial direction, any of the other claw parts 145 is likely to receive the force in the non-detaching direction, and the bus bar holder 140 can be suppressed from detaching from the insulator 25.

Specifically, in the embodiment, the claw parts 145 of the fixing parts 142 connected to the end parts on both sides in the circumferential direction of the bus bar holder body part 141 are disposed on the opposite sides in the radial direction across the central axis J1 and are disposed with an interval of 180° in the circumferential direction. Therefore, for example, when the bus bar holder 140 tries to move in a direction in which one of the two claw parts 145 moves from the hooking part 25d toward the radial-direction outer side, the other claw part 145 is pushed by the outer protrusion part 25b from the radial-direction outer side and is suppressed from detaching from the hooking part 25d. In this way, the bus bar holder 140 can be suppressed from detaching from the insulator 25.

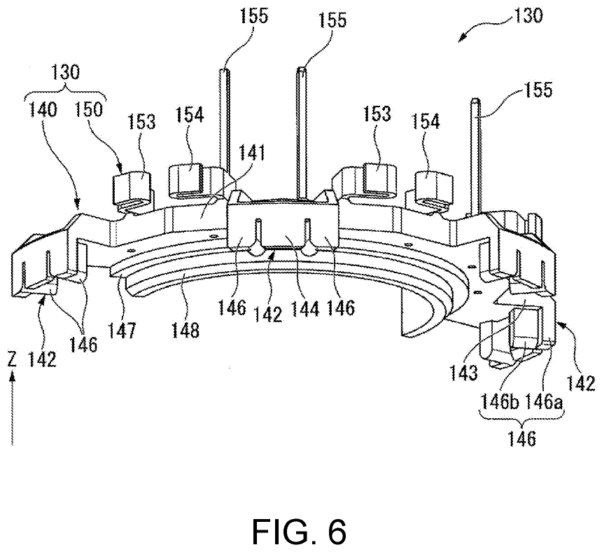

As shown in FIG. 6, the fixing part 142 further has positioning parts 146. The positioning parts 146 protrude from the arm part 143 toward the lower side. The positioning parts 146 are disposed on both sides in the circumferential direction of the extending part 144 with a gap therebetween. The positioning part 146 has a supporting part 146a and a fitting protrusion part 146b. That is, the bus bar holder 140 has the supporting parts 146a and the fitting protrusion parts 146b. The supporting part 146a protrudes from the radial-direction outer-side end part of the arm part 143 toward the lower side. The supporting part 146a is located at the same position as the extending part 144 in the radial direction.

The fitting protrusion part 146b is connected to the radial-direction inner-side surface of the supporting part 146a. The fitting protrusion part 146b protrudes from the arm part 143 toward the lower side on the radial-direction inner side of the supporting part 146a. The fitting protrusion part 146b is fitted to the fitting recess part 25e. In this way, according to the embodiment, the bus bar holder 140 can be positioned with good accuracy in the circumferential direction with respect to the insulator 25.

The circumferential-direction dimension of the lower-side end part of the fitting protrusion part 146b decreases toward the lower side. Therefore, when the bus bar holder 140 is brought close to the insulator 25 from the upper side of the insulator 25 and fixed thereto, even if the bus bar holder 140 and the insulator 25 are shifted in the circumferential direction, the lower-side end part of the fitting protrusion part 146b is easy to insert into in the fitting recess part 25e. In this way, the fitting protrusion part 146b can be easily fitted to the fitting recess part 25e, and the bus bar holder 140 can be easily positioned in the circumferential direction with respect to the insulator 25. In the embodiment, the lower-side surface of the fitting protrusion part 146b is in an arc shape protruding toward the lower side as viewed along the radial direction.

As shown in FIGS. 5 and 6, the bus bar holder 140 further has a support wall part 148. The support wall part 148 protrudes from the radial-direction inner edge part of the bus bar holder body part 141 toward the lower side. The support wall part 148 extends in an arc shape along the circumferential direction. The support wall part 148 is located on the radial-direction inner side of the inner protrusion part 25c. Therefore, the support wall part 148 is hooked from the radial-direction inner side on the inner protrusion part 25c, and the bus bar holder 140 can be suppressed from detaching on the radial-direction outer side. As described above, in the embodiment, the insulator 25 can be clamped from both sides in the radial direction by the extending parts 144, the claw parts 145 and the support wall part 148, and the bus bar holder 140 can be suppressed from moving in the radial direction with respect to the insulator 25.

The bus bar holder 140 further has a supported part 147. The supported part 147 protrudes from the bus bar holder body part 141 toward the lower side. The supported part 147 is located on the radial-direction outer side of the support wall part 148. The supported part 147 is connected to the radial-direction outer-side surface of the support wall part 148. The lower-side end part of the supported part 147 is located above the lower-side end part of the support wall part 148. The supported part 147 is located above the inner protrusion part 25c. The lower-side end part of the supported part 147 contacts the upper-side end part of the inner protrusion part 25c. In this way, the bus bar holder 140 is supported from the lower side by the inner protrusion part 25c. As described above, according to the embodiment, the insulator 25 supports the bus bar holder 140 from the lower side with the outer protrusion part 25b and the inner protrusion part 25c.

As shown in FIG. 4, in the embodiment, three bus bars 150 are provided. The three bus bars 150 are disposed along the circumferential direction. The bus bars 150 are partially embedded in and held by the bus bar holder 140. Each of the bus bars 150 has a bus bar body part 151, bus bar arm parts 152, coil connection parts 153 and 154, and a terminal part 155. The bus bar body part 151 is in an arc shape that extends in the circumferential direction. The bus bar body part 151 is in a plate shape whose plate surface faces the axial direction Z. The bus bar body part 151 is embedded in the bus bar holder body part 141.

The bus bar arm parts 152 are connected to the end parts on both sides in the circumferential direction of the bus bar body part 151. The bus bar arm part 152 has a first part 152a and a second part 152b. The first part 152a is a part that extends from the circumferential-direction end part of the bus bar body 151 toward the radial-direction outer side. The first part 152a is in a plate shape whose plate surface faces the axial direction Z. The first part 152a is embedded in the bus bar holder body part 141. The second part 152b is a part that extends from the edge part on one side in the circumferential direction of the first part 152a toward the radial-direction outer side. As shown in FIG. 3, the second part 152b is in a plate shape whose plate surface faces the circumferential direction. The second part 152b protrudes from the bus bar holder body part 141 toward the upper side. The radial-direction outer-side end part of the second part 152b is located closer to the radial-direction outer side than the radial-direction outer edge part of the bus bar holder body part 141.

The coil connection parts 153 and 154 are respectively connected to the radial-direction outer-side end parts of the bus bar arm parts 152. The coil connection part 153 and the coil connection part 154 are disposed side by side in the circumferential direction. The coil connection part 153 and the coil connection part 154 are located between the arm parts 143 in the fixing parts 142 adjacent in the circumferential direction as viewed along the axial direction Z. The coil connection parts 153 and 154 of each of the bus bars 150 are respectively located between different arm parts 143 as viewed along the axial direction Z. The coil connection part 153 and the coil connection part 154 are in symmetrical shapes in the circumferential direction.

As shown in FIG. 4, the coil connection part 153 has a pair of gripping arm parts 153a and 153b that extend in the circumferential direction and a base part 153c that connects the pair of gripping arm parts 153a and 153b. The gripping arm part 153a extends from the radial-direction outer-side end part of the second part 152b to one side in the circumferential direction. The gripping arm part 153b is disposed to face the radial-direction outer side of the gripping arm part 153a. The base part 153c connects an end part on one side in the circumferential direction of the gripping arm part 153a and an end part on one side in the circumferential direction of the gripping arm part 153b. The coil connection part 153 is in a U shape that opens on the other side in the circumferential direction as viewed along the axial direction Z.

Further, in the embodiment, for example, one side in the circumferential direction is a side that advances counterclockwise with the central axis J1 as the center as viewed from the upper side, and the other side in the circumferential direction is a side that advances clockwise with the central axis J1 as the center as viewed from the upper side.

The coil connection part 154 is located on one side in the circumferential direction of the coil connection part 153. The coil connection part 154 has a pair of gripping arm parts 154a and 154b that extend in the circumferential direction and a base part 154c that connects the pair of gripping arm parts 154a and 154b. The gripping arm part 154a extends from the radial-direction outer-side end part of the second part 152b to the other side in the circumferential direction. In the embodiment, the gripping arm part 153a of the coil connection part 153 and the gripping arm part 154 a of the coil connection part 154 extend from the respective bus bar arm parts 152 toward each other in the circumferential direction. The gripping arm part 154b is disposed to face the radial-direction outer side of the gripping arm part 154a. The base part 154c connects an end part on the other side in the circumferential direction of the gripping arm part 154a and an end part on the other side in the circumferential direction of the gripping arm part 154b. The coil connection part 154 is in a U shape that opens on one side in the circumferential direction as viewed along the axial direction Z. That is, the coil connection part 153 and the coil connection part 154 are in U shapes that open on opposite sides to the other coil connection part in the circumferential direction as viewed along the axial direction Z.

The coil lead wires 26a are clamped and held between the pair of gripping arm parts 153a and 153b and between the pair of gripping arm parts 154a and 154b, respectively. The pair of gripping arm parts 153a and 153b and the coil lead wire 26a are fixed by welding. The pair of gripping arm parts 154a and 154b and the coil lead wire 26a are fixed by welding. In this way, the coil connection part 153 and the coil connection part 154 are each connected to the coil lead wire 26a drawn from the coil 26 toward the upper side. Further, in this way, the bus bars 150 are electrically connected to the stator 23.

In addition, in the coil connection part 153, the tip end parts of the pair of gripping arm parts 153a and 153b may be crimped from both sides in the radial direction to clamp the coil lead wire 26a from both sides in the radial direction. In this case, the tip end part of the gripping arm part 153a may be in contact with the tip end part of the gripping arm part 153b. In this case, the opening of the coil connection part 153 is in a closed state. The same applies to the coil connection part 154.

As shown in FIGS. 3 and 4, in the embodiment, the terminal part 155 extends from the bus bar arm part 152 toward the upper side. More specifically, in two bus bars 150 among the three bus bars 150, the terminal parts 155 extend from the first parts 152a toward the upper side. In the remaining one bus bar 150 among the three bus bars 150, the terminal part 155 extends from the second part 152b toward the upper side. The terminal part 155 extends above the bus bar holder 140. The terminal part 155 is in an elongated quadrangular prism shape. As shown in FIG. 1, the terminal part 155 protrudes above the partition wall part 12b through the hole part 12j and is connected to the circuit board 71 to be described later. In this way, the circuit board 71 is electrically connected to the bus bars 150.

According to the embodiment, the claw part 145 is hooked by the hooking parts 25d, whereby the bus bar holder 140 holding the bus bar 150 is fixed to the insulator 25. Therefore, the coil lead wire 26a drawn from the coil 26 may be fixed to the coil connection parts 153 and 154 of the bus bar 150 fixed to the insulator 25 without passing through the hole part 12j and the like of the partition wall part 12b. Further, since the coil connection parts 153 and 154 of the bus bar 150 can be disposed close to the coil 26, the coil lead wire 26a connected to the coil connection parts 153 and 154 can be shortened. Thus, the position of the coil lead wire 26a can be easily suppressed from moving as compared to the case where the coil lead wire 26a is long. Therefore, the coil lead wire 26a can be easily positioned with respect to the coil connection parts 153 and 154. As described above, the coil lead wire 26a and the bus bar 150 can be easily connected. Therefore, the effort for assembling the stator unit 120 can be reduced.

Further, according to the embodiment, the bus bar 150 has the terminal part 155 that extends above the bus bar holder 140. Since the terminal part 155 is a part of the bus bar 150, its rigidity is relatively higher than that of the coil lead wire 26a. Therefore, when the stator unit 120 is inserted into the motor case 12 from the lower side, the terminal part 155 is unlikely to bend, and the position of the terminal part 155 is unlikely to shift. Thus, the terminal part 155 can be easily passed through the hole part 12j of the partition wall part 12b, and the terminal part 155 can be easily connected to the circuit board 71 to be described later. Therefore, the stator unit 120 is easily disposed in the inner part of the motor case 12, and the terminal part 155 can be easily connected to the circuit board 71.

As described above, according to the embodiment, the stator unit 120 can be easily assembled, and the stator unit 120 in the electric actuator 10 can also be easily assembled. Therefore, the effort for assembling the electric actuator 10 can be reduced.

Further, according to the embodiment, by fixing the bus bar holder 140 to the insulator 25, the stress applied to the bus bar holder 140 can be received by the insulator 25. Therefore, stress can be suppressed from applying to the connection part between the coil lead wire 26a and the coil connection parts 153 and 154. In this way, the coil lead wire 26a can be made unlikely to detach from the coil connection parts 153 and 154. Therefore, the reliability of the stator unit 120 can be improved.

Further, according to the embodiment, the coil connection parts 153 and 154 are located between the arm parts 143 of the fixing parts 142 adjacent in the circumferential direction as viewed along the axial direction Z. Therefore, the coil connection parts 153 and 154 can be easily disposed immediately above the coil 26, and the coil lead wire 26a can be easily connected to the coil connection parts 153 and 154. Moreover, the space which connects the coil connection parts 153 and 154 and the coil lead wire 26a can be ensured easily.

The control part 70 includes the circuit board 71, a second attachment member 73, a second magnet 74, and a second rotation sensor 72. That is, the electric actuator 10 includes the circuit board 71, the second attachment member 73, the second magnet 74, and the second rotation sensor 72.

The circuit board 71 is in a plate shape that expands in a plane orthogonal to the axial direction Z. The circuit board 71 is accommodated in the motor case 12. More specifically, the circuit board 71 is accommodated in the control board accommodating part 12f and is disposed closer to the upper side than the partition wall part 12b. That is, the circuit board 71 is accommodated in a part in the inner part of the case cylinder part 12a above the partition wall part 12b. The circuit board 71 is a board electrically connected to the motor 20. The coils 26 of the stator 23 are electrically connected to the circuit board 71 via the bus bars 150. The circuit board 71, for example, controls the current supplied to the motor 20. That is, an inverter circuit is mounted on the circuit board 71, for example.

The second attachment member 73 is in an annular shape with the central axis J1 as the center. The inner circumferential surface of the second attachment member 73 is fixed to the upper end part of the motor shaft 21. The second attachment member 73 is disposed above the first bearing 51 and the bearing holder 100. The second attachment member 73 is, for example, a nonmagnetic material. Further, the second attachment member 73 may be a magnetic material.

The second magnet 74 is in an annular shape with the central axis J1 as the center. The second magnet 74 is fixed to the upper end surface of the radial-direction outer edge part of the second attachment member 73. The method of fixing the second magnet 74 to the second attachment member 73 is not particularly limited, and is, for example, adhesion using an adhesive. The second attachment member 73 and the second magnet 74 rotate together with the motor shaft 21. The second magnet 74 is disposed above the first bearing 51 and the holder cylinder part 101. The second magnet 74 has N poles and S poles alternately disposed along the circumferential direction.

The second rotation sensor 72 is a sensor that detects the rotation of the motor 20. The second rotation sensor 72 is attached to the lower surface of the circuit board 71. The second rotation sensor 72 faces the second magnet 74 in the axial direction Z with a gap therebetween. The second rotation sensor 72 detects the magnetic field generated by the second magnet 74. The second rotation sensor 72 is, for example, a Hall element. Though omitted in the drawings, for example, a plurality of (three, for example) second rotation sensors 72 are provided along the circumferential direction. The second rotation sensor 72 can detect the rotation of the motor shaft 21 by detecting the change of the magnetic field generated by the second magnet 74 rotating with the motor shaft 21.

The connector part 80 is a part where connection with electrical wiring outside the case 11 is performed. The connector part 80 is provided on the motor case 12. The connector part 80 has the terminal holding part 12d described above and the terminal 81. The terminal 81 is embedded in and held by the terminal holding part 12d One end of the terminal 81 is fixed to the circuit board 71. The other end of the terminal 81 is exposed to the outside of the case 11 through the inner part of the terminal holding part 12d In the embodiment, the terminal 81 is, for example, a bus bar.

An external power supply is connected to the connector part 80 via an electrical wiring (not shown). More specifically, an external power supply is attached to the terminal holding part 12d, and the electrical wiring of the external power supply is electrically connected to the part of the terminal 81 protruding into the terminal holding part 12d In this way, the terminal 81 electrically connects the circuit board 71 and the electrical wiring. Therefore, in the embodiment, power is supplied from the external power supply to the coils 26 of the stator 23 via the terminal 81 and the circuit board 71.

The deceleration mechanism 30 is disposed on the radial-direction outer side of the lower-side part of the motor shaft 21. The deceleration mechanism 30 is accommodated inside the deceleration mechanism case 13. The deceleration mechanism 30 is disposed between the bottom wall part 13a as well as the annular part 16b and the motor 20 in the axial direction Z. The deceleration mechanism 30 has an external gear 31, a plurality of protrusion parts 32, an internal gear 33, and an output flange part 42.

The external gear 31 is in a substantially annular plate shape that expands in a plane orthogonal to the axial direction Z with the eccentric axis J2 of the eccentric axis part 21a as the center. As shown in FIG. 2, a gear part is provided on the radial-direction outer-side surface of the external gear 31. The external gear 31 is connected to the eccentric axis part 21a via the third bearing 53. In this way, the deceleration mechanism 30 is connected to the lower-side part of the motor shaft 21. The external gear 31 is fitted to the outer ring of the third bearing 53 from the radial-direction outer side. In this way, the third bearing 53 connects the motor shaft 21 and the external gear 31 to be relatively rotatably around the eccentric axis J2.

As shown in FIG. 1, the plurality of protrusion parts 32 protrude from the external gear 31 toward the output flange part 42 in the axial direction Z. The protrusion part 32 is in a cylindrical shape that protrudes to the lower side. As shown in FIG. 2, the plurality of protrusion parts 32 are disposed along the circumferential direction. More specifically, the plurality of protrusion parts 32 are disposed at equal intervals all around along the circumferential direction with the eccentric axis J2 as the center.

The internal gear 33 is fixed and surrounds the radial-direction outer side of the external gear 31 and engages with the external gear 31. The internal gear 33 is in an annular shape with the central axis J1 as the center. As shown in FIG. 1, the internal gear 33 is located on radial-direction inner side of the upper-side end part of the cylinder member 16. The internal gear 33 is fixed to the inner circumferential surface of the cylinder member 16 made of metal. Therefore, the internal gear 33 can be firmly fixed to the deceleration mechanism case 13 while the deceleration mechanism case body 13i is made of resin. Thus, the internal gear 33 can be suppressed from moving with respect to the deceleration mechanism case 13, and the position of the internal gear 33 can be suppressed from shifting. In the embodiment, the internal gear 33 is fixed to the inner circumferential surface of the large diameter part 16a by press fitting. In this way, the deceleration mechanism 30 is fixed to the inner circumferential surface of the cylinder member 16 and held by the deceleration mechanism case 13. As shown in FIG. 2, a gear part is provided on the inner circumferential surface of the internal gear 33. The gear part of the internal gear 33 engages with the gear part of the external gear 31. More specifically, the gear part of the internal gear 33 engages with the gear part of the external gear 31 in part.

The internal gear 33 has a positioning protrusion part 33a that protrudes toward radial-direction outer side. The positioning protrusion part 33a is fitted to the positioning recess part 16d provided in the large diameter part 16a. In this way, the positioning protrusion part 33a is hooked to the positioning recess part 16d, whereby the internal gear 33 can be suppressed from relatively rotating with respect to the cylinder member 16 in the circumferential direction.

The output flange part 42 is a part of the output part 40. The output flange part 42 is located below the external gear 31. The output flange part 42 is in an annular plate shape that expands in the radial direction with the central axis J1 as the center. The output flange part 42 expands from the upper-side end part of an output shaft 41 to be described later toward the radial-direction outer side. As shown in FIG. 1, the output flange part 42 contacts the bush flange part 54a from the upper side.

The output flange part 42 has a plurality of pit parts 42a. In the embodiment, the plurality of pit parts 42a pass through the output flange part 42 in the axial direction Z. As shown in FIG. 2, the shape of the pit part 42a as viewed along the axial direction Z is a circular shape. The inner diameter of the pit part 42a is greater than the outer diameter of the protrusion part 32. The plurality of protrusion parts 32 provided on the external gear 31 are respectively inserted into the plurality of pit parts 42a. The outer circumferential surface of the protrusion part 32 is inscribed in the inner circumferential surface of the pit part 42a. The inner circumferential surfaces of the pit parts 42a support the external gear 31 to be swingable around the central axis J1 via the protrusion parts 32. In other words, the plurality of protrusion parts 32 support the external gear 31 to be swingable around the central axis J1 via the inner-side surfaces of the pit parts 42a.

The output part 40 is a part that outputs the driving force of the electric actuator 10. As shown in FIG. 1, the output part 40 is accommodated in the deceleration mechanism case 13. The output part 40 has the output shaft 41 and the output flange part 42. That is, the electric actuator 10 includes the output shaft 41 and the output flange part 42. In the embodiment, the output part 40 is a single member.

The output shaft 41 extends in the axial direction Z of the motor shaft 21 on the lower side of the motor shaft 21. The output shaft 41 has a cylinder part 41a and an output shaft body part 41b. The cylinder part 41a is in a cylindrical shape that extends from the inner edge of the output flange part 42 toward the lower side. The cylinder part 41a is in a cylindrical shape that has a bottom part and opens on the upper side. The cylinder part 41a is fitted to the radial-direction inner side of the bush 54. In this way, the output shaft 41 is rotatably supported by the cylinder member 16 via the bush 54. As described above, the deceleration mechanism 30 is fixed to the cylinder member 16. Therefore, the deceleration mechanism 30 and the output shaft 41 can be supported together by the cylinder member 16 made of metal. In this way, the deceleration mechanism 30 and the output shaft 41 can be disposed with good axial accuracy. The second bearing 52 is accommodated in the inner part of the cylinder part 41a. The outer ring of the second bearing 52 is fitted to the inner part of the cylinder part 41a. In this way, the second bearing 52 connects the motor shaft 21 and the output shaft 41 to be rotatable relative to each other. The lower end part of the motor shaft 21 is located in the inner part of the cylinder part 41a. The lower end surface of the motor shaft 21 faces the upper surface of the bottom part of the cylinder part 41a with a gap therebetween.

The output shaft body part 41b extends from the bottom part of the cylinder part 41a toward the lower side. In the embodiment, the output shaft body part 41b is in a cylindrical shape with the central axis J1 as the center. The outer diameter of the output shaft body part 41b is smaller than the outer diameter and the inner diameter of the cylinder part 41a. The lower end part of the output shaft body part 41b protrudes lower than the protruding cylinder part 13c. Another member to which the driving force of the electric actuator 10 is output is attached to the lower end part of the output shaft body part 41b.

When the motor shaft 21 is made to rotate around the central axis J1, the eccentric axis part 21a revolves in the circumferential direction with the central axis J1 as the center. The revolution of the eccentric axis part 21a is transmitted to the external gear 31 via the third bearing 53, and the external gear 31 swings while its position inscribed in the inner circumferential surfaces of the pit parts 42a and the outer circumferential surfaces of the protrusion parts 32 changes. Thus, the position where the gear part of the external gear 31 and the gear part of the internal gear 33 engage with each other changes in the circumferential direction. Therefore, the rotational force of the motor shaft 21 is transmitted to the internal gear 33 via the external gear 31.

Here, in the embodiment, since the internal gear 33 is fixed, it does not rotate. Therefore, the external gear 31 is rotated around the eccentric axis J2 by the reaction force of the rotational force transmitted to the internal gear 33. At this time, the rotation direction of the external gear 31 is opposite to the rotation direction of the motor shaft 21. The rotation of the external gear 31 around the eccentric axis J2 is transmitted to the output flange part 42 via the pit parts 42a and the protrusion parts 32. Thus, the output shaft 41 rotates around the central axis J1. Therefore, the rotation of the motor shaft 21 is transmitted to the output part 40 via the deceleration mechanism 30.

The rotation of the output shaft 41 is decelerated by the deceleration mechanism 30 with respect to the rotation of the motor shaft 21. Specifically, in the configuration of the deceleration mechanism 30 of the embodiment, a deceleration ratio R of the rotation of the output shaft 41 with respect to the rotation of the motor shaft 21 is represented by R=−(N2−N1)/N2. The negative sign at the beginning of the equation representing the deceleration ratio R indicates that the rotation direction of the output shaft 41 to be decelerated is opposite to the rotation direction of the motor shaft 21. N1 is the teeth number of the external gear 31, and N2 is the teeth number of the internal gear 33. As an example, when the teeth number N1 of the external gear 31 is 59 and the teeth number N2 of the internal gear 33 is 60, the deceleration ratio R is −1/60.

Thus, according to the deceleration mechanism 30 of the embodiment, the deceleration ratio R of the rotation of the output shaft 41 with respect to the rotation of the motor shaft 21 can be made relatively large. Therefore, the rotational torque of the output shaft 41 can be made relatively large.

The rotation detection device 60 detects the rotation of the output part 40. The rotation detection device 60 has the first magnet 63, a covering part 62, and a first rotation sensor 61. The first magnet 63 is in an annular shape with the central axis J1 as the center. The first magnet 63 is attached to the output part 40. More specifically, the first magnet 63 is fixed to the lower surface of the output flange part 42. The first magnet 63 is located below the protrusion parts 32. The lower-side end part of the first magnet 63 faces the upper side of the annular part 16b with a gap therebetween.

The first rotation sensor 61 is located inside the accommodating recess part 17. The first rotation sensor 61 is located below the first magnet 63 with the annular part 16b interposed therebetween. The first rotation sensor 61 detects the magnetic field generated by the first magnet 63. The first rotation sensor 61 is, for example, a Hall element. The first rotation sensor 61 can detect the rotation of the output part 40 by detecting the change of the magnetic field generated by the first magnet 63 rotating with the output part 40. Here, according to the embodiment, the cylinder member 16 is a nonmagnetic material. Therefore, even if the cylindrical member 16 is located between the first magnet 63 and the first rotation sensor 61, the detection accuracy of the magnetic field of the first magnet 63 by the first rotation sensor 61 can be suppressed from lowering.

The covering part 62 is located inside the accommodating recess part 17. In the embodiment, the covering part 62 is filled inside the accommodating recess part 17. The covering part 62 is made of resin. The first rotation sensor 61 is embedded in and covered by the covering part 62.

The wiring member 90 is electrically connected to the first rotation sensor 61. In the embodiment, the wiring member 90 is a member for connecting the first rotation sensor 61 of the rotation detection device 60 and the circuit board 71 of the control part 70. In the embodiment, the wiring member 90 is an elongated plate-shaped bus bar. Though omitted in the drawings, three wiring members 90 are provided in the embodiment. Each of the wiring members 90 is configured by connecting the first wiring member 91 and the second wiring member 92.

The first wiring member 91 extends from the inner part of the second wiring holding part 15 to the inner part of the control board accommodating part 12f. A part of the first wiring member 91 is embedded in the first wiring holding part 14, the case cylinder part 12a and the wall part body 12i. In this way, the first wiring member 91 is held by the motor case 12.

The lower end part 91a of the first wiring member 91 protrudes from the first wiring holding part 14 to the lower side and is located inside the second wiring holding part 15. The upper end part 91b of the first wiring member 91 protrudes from the wall part body 12i to the upper side and is connected to the circuit board 71. In this way, the first wiring member 91 is electrically connected to the circuit board 71 and electrically connected to the electrical wiring outside the case 11 via the connector part 80.

A part of the second wiring member 92 is embedded in the bottom part 13j. In this way, the second wiring member 92 is held by the deceleration mechanism case 13. The upper end part 92a of the second wiring member 92 protrudes from the bottom wall part 15a to the upper side. The upper end part 92a of the second wiring member 92 is connected to the lower end part 91a of the first wiring member 91. The lower end part 92b of the second wiring member 92 passes through the bottom part 13j and protrudes to the inner part of accommodating recess part 17. The lower end part 92b corresponds to one end part of the wiring member 90. Therefore, the wiring member 90 passes through the case 11 from the inner part of the case 11, and one end part thereof protrudes to the inner part of accommodating recess part 17. The lower end part 92b is connected to the first rotation sensor 61. Thus, the first rotation sensor 61 is connected to one end part of the wiring member 90. The lower end part 92b is embedded in and covered by the covering part 62. As described above, since one end part of the wiring member 90 and the first rotation sensor 61 are embedded in and covered by the covering part 62, moisture or the like can be prevented from contacting the one end part of the wiring member 90 and the first rotation sensor 61 located in the accommodating recess part 17.

According to the embodiment, the inner diameter of the through hole 12h is greater than the outer diameter of the holder cylinder part 101, and at least a part of the radial-direction outer-side surface of the holder cylinder part 101 in the circumferential direction is located at a position closer to the radial-direction inner side than the radial-direction inner-side surface of the through hole 12h. Therefore, before the bearing holder 100 is fixed to the partition wall part 12b, the bearing holder 100 can be moved in the radial direction for an amount of the gap between the radial-direction inner-side surface of the through hole 12h and the radial-direction outer-side surface of the holder cylinder 101. Thus, the radial-direction position of the first bearing 51 with respect to the motor case 12 can be adjusted. Therefore, even if the radial-direction position of the second bearing 52 with respect to the motor case 12 shifts due to, for example, an assembly error and the like, the radial-direction position of the first bearing 51 can be aligned with the radial-direction position of the second bearing 52, and the first bearing 51 and the second bearing 52 can be disposed with good axial accuracy. Therefore, the motor shaft 21 supported by the first bearing 51 and the second bearing 52 can be suppressed from inclining, and the axial accuracy of the motor shaft 21 can be improved. Therefore, noise and vibration generated by the electric actuator 10 can be suppressed from increasing.

Further, each of the drawings shows a configuration in which the center of the holder cylinder part 101 and the center of the through hole 12h both coincide with the central axis J1 and in which the entire circumference of the radial-direction outer-side surface of the holder cylinder part 101 is closer to the radial-direction inner side than the radial-direction inner-side surface of the through hole 12h, but the configuration is not limited thereto. Depending on the adjustment amount of the radial-direction position of the bearing holder 100, the center of the through hole 12h does not necessarily coincide with the central axis J1. In addition, a part of the radial-direction outer-side surface of the holder cylinder part 101 may be in contact with the radial-direction inner-side surface of the through hole 12h.

Further, according to the embodiment, the second bearing 52 connects the motor shaft 21 and the output shaft 41 to be rotatable relative to each other. Therefore, by improving the axial accuracy of the first bearing 51 and the second bearing 52, the axial accuracy of the motor shaft 21 and the output shaft 41 can be improved.

Further, when the motor shaft 21 and the output shaft 41 are connected by the second bearing 52, the second bearing 52 is indirectly supported by the deceleration mechanism case 13 via the output shaft 41. Therefore, as compared with the case where the second bearing 52 is directly supported by the deceleration mechanism case 13, the position of the second bearing 52 is likely to be unstable, and the axis of the motor shaft 21 is easily shaken. In this regard, according to the embodiment, since the axial accuracy of the motor shaft 21 can be improved as described above, the axis of the motor shaft 21 can be suppressed from shaking. That is, when the motor shaft 21 and the output shaft 41 are connected by the second bearing 52, the effect of being able to improve the axial accuracy of the motor shaft 21 in the embodiment can be obtained more usefully.

The disclosure is not limited to the above-described embodiment and can adopt other configurations. The hooking part may protrude from the inner protrusion part toward the radial-direction inner side. In this case, the extending part is located on the radial-direction inner side of the inner protrusion part, and the claw part protrudes from the extending part toward the radial-direction outer side. The claw part may be provided in one of the bus bar holder and the insulator, and the hooking part may be provided in the other of the bus bar holder and the insulator. That is, the insulator may have the claw part, and the bus bar holder may have the hooking part. The number of the claw part and the hooking part is not particularly limited. The fitting recess part and the fitting protrusion part are not necessarily provided. The shape of the coil connection part is not particularly limited. The coil connection parts may each be in a U shape that opens on the same side in the circumferential direction.

The first recess part may be provided at any position. The first recess part may be provided on the radial-direction outer-side surface of the deceleration mechanism case, may be provided on the radial-direction outer-side surface of the motor case, may be provided on the upper-side surface of the motor case, or may be provided on the inner-side surface of the case. The first rotation sensor is not particularly limited as long as it can detect the rotation of the output part. The first rotation sensor may be a magnetoresistive element. The covering part may be provided only in a part of the inner part of the first recess part as long as it covers the one end part of the wiring member and the first rotation sensor. The covering part is not necessarily provided. The cylinder member is not necessarily provided.

The number of screw members for fixing the bearing holder to the wall part is not particularly limited. The method of fixing the bearing holder to the wall part is not limited to the screw members and is not particularly limited. For example, the bearing holder may be fixed to the wall part with the use of an adhesive, or the bearing holder may be fixed to the wall part by welding. The bearing holder is not necessarily made of sheet metal. For example, the bearing holder may be manufactured by die casting.

The wall part does not necessarily have a metal member. In this case, for example, the wall part body may be made of metal, and internal thread holes may be provided in the wall part body. The deceleration mechanism is not particularly limited. In the above-described embodiment, the plurality of protrusion parts 32 are configured to protrude from the external gear 31 toward the output flange part 42 in the axial direction Z, but the disclosure is not limited thereto. The plurality of protrusion parts may protrude from the output flange toward the external gear in the axial direction Z. In this case, the external gear has a plurality of pit parts.

Further, the stator unit of the above-described embodiment may be a stator unit of a motor mounted on a machine other than an electric actuator. Moreover, the use of the electric actuator of the above-described embodiment is not limited, and the electric actuator of the above-described embodiment may be mounted on any machine. The electric actuator of the above-described embodiment is mounted on, for example, a vehicle. Moreover, each of the configurations described in the specification can be combined as appropriate in the range without contradiction with each other.

What is claimed is:

1. A stator unit of a motor which has a motor shaft rotating with a central axis as a center and a rotor body fixed to the motor shaft, the stator unit comprising:
a stator facing the rotor body in a radial direction with a gap therebetween; and
a bus bar unit having a bus bar electrically connected to the stator,
wherein the stator has
a stator core in an annular shape along a circumferential direction;
an insulator attached to the stator core; and
a plurality of coils attached to the stator core via the insulator,
the bus bar unit has a bus bar holder for holding the bus bar on one side in an axial direction of the insulator,
the bus bar has
a terminal part extending closer to the one side in the axial direction than the bus bar holder; and
a coil connection part connected to a coil lead wire drawn from the coils to the one side in the axial direction,
one of the bus bar holder and the insulator has a claw part protruding in the radial direction, and
the other of the bus bar holder and the insulator has a hooking part to which the claw part is hooked and fixed in the axial direction.

2. The stator unit according to claim 1, wherein the stator core has
a core back part in an annular shape along the circumferential direction; and
a teeth part extending from the core back part in the radial direction, the insulator has
a cylinder part through which the teeth part passes and to which the coils are attached;
an outer protrusion part protruding from the cylinder part toward the one side in the axial direction closer to a radial-direction outer side than the coils; and
an inner protrusion part protruding from the cylinder part toward the one side in the axial direction closer to a radial-direction inner side than the coils,
the bus bar holder has
a bus bar holder body part extending in the circumferential direction on the one side in the axial direction of the insulator; and
a plurality of fixing parts which are connected to a radial-direction outer edge part of the bus bar holder body part and are disposed along the circumferential direction,
the fixing parts have
extending parts extending in the axial direction on the radial-direction outer side of the outer protrusion part; and
the claw parts protruding from the extending parts toward the radial-direction inner side,
the claw part is hooked from the other side in the axial direction by the hooking part on the radial-direction outer side of the outer protrusion part.

3. The stator unit according to claim 2, wherein the fixing parts have arm parts extending from the bus bar holder body part toward the radial-direction outer side,
the extending parts extend from radial-direction outer-side end parts of the arm parts to the other side in the axial direction, and
the coil connection part is located between the arm parts in the fixing parts adjacent in the circumferential direction as viewed along the axial direction.

4. The stator unit according to claim 2, wherein a central angle of the bus bar holder body part is 180° or more, and
the claw part includes at least two claw parts which are spaced apart from each other by 180° or more in the circumferential direction along the bus bar holder body part.

5. The stator unit according to claim 3, wherein a central angle of the bus bar holder body part is 180° or more, and
the claw part includes at least two claw parts which are spaced apart from each other by 180° or more in the circumferential direction along the bus bar holder body part.

6. The stator unit according to claim 2, wherein the bus bar holder has a support wall part protruding from a radial-direction inner edge part of the bus bar holder body part toward the other side in the axial direction, and
the support wall part is located on the radial-direction inner side of the inner protrusion part.

7. The stator unit according to claim 1, wherein the insulator has a fitting recess part recessed toward the other side in the axial direction,
the bus bar holder has a fitting protrusion part fitted to the fitting recess part, and
a circumferential-direction dimension at an end part of the fitting protrusion part on the other side in the axial direction decreases toward the other side in the axial direction.

8. An electric actuator, comprising:
a motor which has a motor shaft rotating with a central axis as a center, a rotor body fixed to the motor shaft, and the stator unit according to claim 1;
a deceleration mechanism connected to a part on the other side in the axial direction of the motor shaft;
an output part to which rotation of the motor shaft is transmitted via the deceleration mechanism;
a first case which accommodates the motor and has a first opening part that opens on the other side in the axial direction;
a second case which is located on the other side in the axial direction of the first case and has a second opening part that opens on the one side in the axial direction; and
a circuit board electrically connected to the bus bar,
wherein the first case has
a case cylinder part in a cylindrical shape extending in the axial direction; and
a partition wall part expanding from an inner circumferential surface of
the case cylinder part toward a radial-direction inner side,
the stator is fixed to a part in the inner circumferential surface of the case cylinder part closer to the other side in the axial direction than the partition wall part,
the circuit board is accommodated in a part in an inner part of the case cylinder part closer to the one side in the axial direction than the partition wall part,
the partition wall part has a hole part passing through the partition wall part in the axial direction, and
the terminal part protrudes closer to the one side in the axial direction than the partition wall part through the hole part and is connected to the circuit board.

9. The electric actuator according to claim 8, wherein the stator core has
a core back part in an annular shape along the circumferential direction; and
a teeth part extending from the core back part in the radial direction,
the insulator has
a cylinder part through which the teeth part passes and to which the coils are attached;
an outer protrusion part protruding from the cylinder part toward the one side in the axial direction closer to a radial-direction outer side than the coils; and
an inner protrusion part protruding from the cylinder part toward the one side in the axial direction closer to a radial-direction inner side than the coils,
the bus bar holder has
a bus bar holder body part extending in the circumferential direction on the one side in the axial direction of the insulator; and
a plurality of fixing parts which are connected to a radial-direction outer edge part of the bus bar holder body part and are disposed along the circumferential direction,
the fixing parts have
extending parts extending in the axial direction on the radial-direction outer side of the outer protrusion part; and
the claw parts protruding from the extending parts toward the radial-direction inner side,
the claw part is hooked from the other side in the axial direction by the hooking part on the radial-direction outer side of the outer protrusion part.

10. The electric actuator according to claim 9, wherein the fixing parts have arm parts extending from the bus bar holder body part toward the radial-direction outer side,
the extending parts extend from radial-direction outer-side end parts of the arm parts to the other side in the axial direction, and
the coil connection part is located between the arm parts in the fixing parts adjacent in the circumferential direction as viewed along the axial direction.

11. The electric actuator according to claim 9, wherein a central angle of the bus bar holder body part is 180° or more, and
the claw part includes at least two claw parts which are spaced apart from each other by 180° or more in the circumferential direction along the bus bar holder body part.

12. The electric actuator according to claim 10, wherein a central angle of the bus bar holder body part is 180° or more, and
the claw part includes at least two claw parts which are spaced apart from each other by 180° or more in the circumferential direction along the bus bar holder body part.

13. The electric actuator according to claim 9, wherein the bus bar holder has a support wall part protruding from a radial-direction inner edge part of the bus bar holder body part toward the other side in the axial direction, and
the support wall part is located on the radial-direction inner side of the inner protrusion part.

14. The electric actuator according to claim 8, wherein the insulator has a fitting recess part recessed toward the other side in the axial direction,
the bus bar holder has a fitting protrusion part fitted to the fitting recess part, and
a circumferential-direction dimension at an end part of the fitting protrusion part on the other side in the axial direction decreases toward the other side in the axial direction.
